(19) United States
(12) Patent Application Publication
(10) Pub. No.: US 2007/0084322 A1
(43) Pub. Date: Apr. 19, 2007

(54) APPARATUS FOR CUTTING A LINE OF PERFORATION IN A FABRIC

(75) Inventor: Timothy A. Williams, S. Elgin, IL (US)

Correspondence Address: KIRTON AND MCCONKIE, 60 EAST SOUTH TEMPLE,, SUITE 1800, SALT LAKE CITY, UT, 84111, US

(73) Assignees: INTERWRAP INC., British Columbia (CA); IBCO SRL, St. Michael (BB)

(21) Appl. No.: 11/551,174

(22) Filed: Oct. 19, 2006

Related U.S. Application Data
(60) Provisional application No. 60/728,186, filed on Oct. 19, 2005.

(51) Int. Cl. B26F 1/24

(52) U.S. Cl. 83/13; 83/660

(57) ABSTRACT

An apparatus for cutting lines of perforation in a sheet material, for example sheets of flexible fabric or wrapping material made of woven thermoplastic tapes or threads, has a pair of cutting blades spaced from each other and each having a plurality of teeth which are straight or oriented at an angle relative to the base of the blade and are generally parallel to each other. The angle of the teeth of the second blade is oriented in an opposite direction to the angle of the teeth of the first blade. The teeth of the second cutting blade are offset relative to those of the first blade.

### CROSS-REFERENCE TO RELATED APPLICATION

This application claims the benefit of provisional application No. 60/728,186, filed Oct.19, 2005.

### Technical Field of the Invention

The invention pertains to an apparatus and method for cutting lines of perforation in sheet material, and to sheet materials which have such lines of perforation.

### BACKGROUND OF THE INVENTION

Fabrics and wrapping materials for industrial use, for example for protective wrapping of lumber, metal coils, for covering pallets, etc., are commonly in the form of elongated sheets (i.e. strips) in roll form. Such fabrics and materials commonly comprise a woven scrim made of thermoplastic tapes running in the machine and cross directions. To make a sheet having the length required for a particular application, a user has to cut a length off the roll.

It would be convenient for such materials to have lines of perforation at intervals along their length to enable a user to tear off a piece of a selected size. The difficulty has been in getting a clean tear line, as tapes that are not completely cut in making the perforations often produce “stringers,”leaving a jagged and commercially unacceptable tear line. The present invention is intended to overcome this deficiency in the prior art by providing means for producing lines of perforation which result in a clean tear line in the product.

### SUMMARY OF THE INVENTION

The invention provides an apparatus for cutting lines of perforation in a sheet material, for example sheets of flexible fabric or wrapping material made of woven thermoplastic tapes or threads. The apparatus has a pair of cutting blades spaced from each other and each having a plurality of teeth which are straight or oriented at an angle relative to the base of the blade and are generally parallel to each other. The angle of the teeth of the second blade is oriented in an opposite direction to the angle of the teeth of the first blade. The teeth of the second cutting blade are offset relative to those of the first blade.

The invention also provides a method for cutting a line of perforation in a sheet of material, comprising the steps of providing the perforating apparatus and bringing it into contact with the sheet of material.

The invention also provides an elongated sheet of flexible material having lines of perforation extending between its longitudinal edges. A line of perforation comprises a first set of cuts which are spaced apart and are generally parallel to each other and at an angle relative to the cross-direction of the sheet, and a second set of such cuts that are spaced from and are generally parallel to the first set of cuts, the cuts of the second set being offset relative to those of the first set.

### BRIEF DESCRIPTION OF THE DRAWINGS

FIG. 1 is a side view of one blade of a preferred embodiment of the perforation-cutting apparatus.

FIG. 2A is an edge view of the apparatus with two blades, looking at the blades edge on in the direction of the line 2-2 of FIG. 1.

FIG. 2B is a close-up view of a portion of the view of FIG. 2A.

FIG. 3 is a plan view of a portion of a line of perforation cut in a sheet of material.

FIG. 4 is a plan view of a sheet of material having lines of perforation cut therein.

### DESCRIPTION OF THE PREFERRED EMBODIMENTS OF THE INVENTION

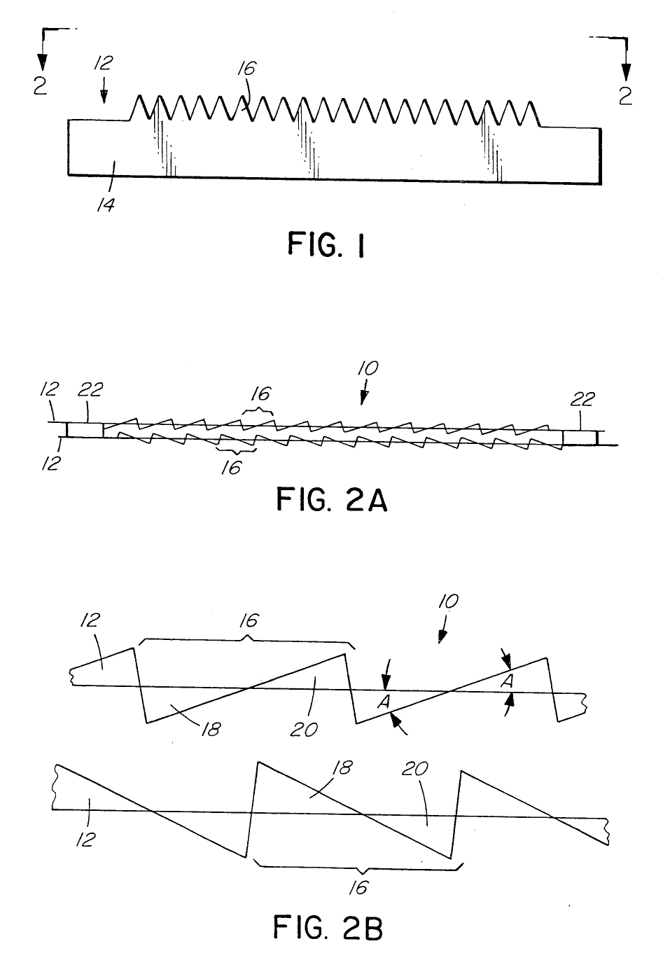

FIG. 1 shows one of the blades 12 that are components of the perforating apparatus 10. Blade 12 has a base 14 and a set of pointed teeth 16 positioned along one edge adjacent to each other. As best seen in FIGS. 2A and 2B, each tooth 16 is twisted at an angle A relative to the base 14, such that one portion 18 of the tooth is on one side of the plane of the blade and the other portion 20 is on the opposite side of the plane. The teeth are generally parallel to each other and are set an angle that is preferably in the range of about 5° to 70°, more preferably about 20° to 45°.

The perforating apparatus 10 has two such blades 12. They are spaced apart by spacers 22 and positioned such that the angles A formed by the teeth relative to the blades are opposite as between the two blades.

Further, the blades are held in a position relative to each other such that the teeth of each one are in an offset, i.e. staggered, position, relative to the teeth 25 of the other blade. In the preferred embodiment, the amount of such offset is one-half the width of a tooth, as best seen in FIG. 2B. (The “width” of a tooth refers to its longitudinal extension along the blade edge, taken at its base.) A lesser amount of offset can be provided if desired by adjusting the positions of the two blades relative to each other in the longitudinal direction.

The distance between the two blades, as determined by spacers 22, is preferably in the range of 1/32 to ¼ inches, and more preferably about 1/16th inch. The greater the space, the greater the tear resistance of a line of perforation produced by the perforating apparatus, and conversely, the narrower the space the lesser is the tear resistance. Accordingly, the width of the spacers 22, i.e. the distance between the two blades, is a matter of choice depending on the tear-resistance properties desired in the perforated sheet material.

The longitudinal offsetting of the teeth of one blade relative to the other produces an overlapping of the cutting teeth of the apparatus along its length, and accordingly an overlapping of the cuts made by the apparatus in a sheet of material. This causes most of the longitudinal (machine-direction) tapes or threads of the sheet material to be cut twice in forming the line of perforation.

In apparatus 10, the blades 12 and spacers 22 are affixed together by clamps or other suitable means (not shown in the drawings). In use, the apparatus is supported in a frame or holding device so as to enable it to be brought into contact with the sheet of material to be perforated. The apparatus is particularly intended for use in the high-speed fabrication of rolls of sheet material, to form lines of perforation at selected intervals along the sheet. For such uses, means are provided for the high speed and repeated application of the apparatus 10 to the sheet prior to the winding of the sheet onto a wind-up roll.

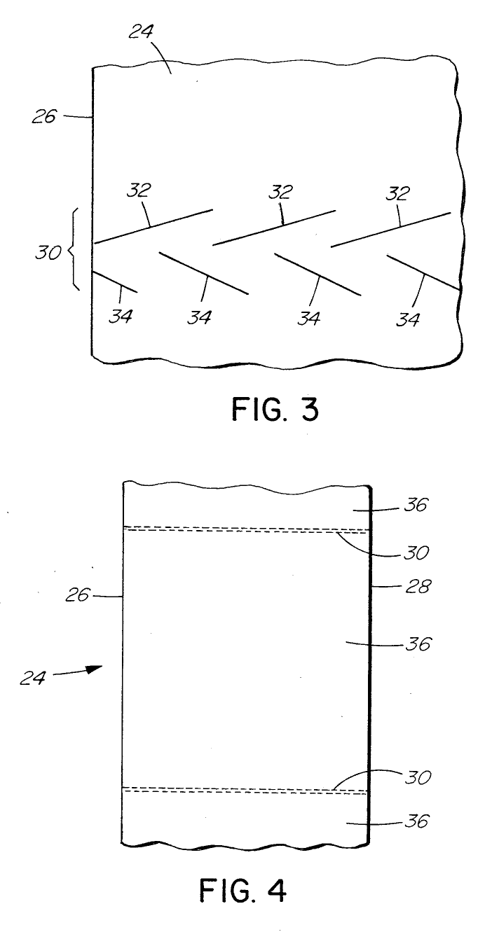

Referring next to FIGS. 3 and 4, an elongated sheet 24 comprises woven tapes running in the machine and the cross directions. It has longitudinal edges 26, 28 parallel to the machine direction and lines of perforation 30 perpendicular to the machine direction that are made by apparatus 10. Perforation line 30 comprises a plurality of cuts 32 made by one of the blades 12 and a plurality of cuts 34 made by the other blade, forming an overlapping and angled (relative to the cross direction of the sheet) set of cuts. The lines of perforation 30 divide the sheet into a plurality of adjacent sections 36.

Though the sheet is perforated, the connection of the sections 36 of the sheet across the lines of perforation is sufficiently strong to permit normal processing and handling of the sheet without breaking the lines of perforation. However, the sheet can be cleanly torn across a line of perforation 30, enabling a user to tear off a length of the sheet of one or more sections 36.

Persons skilled in the art will understand that the apparatus of the invention can be structured in ways other than that shown in the preferred embodiment. For example, rather than having two separate blades, the apparatus could have a single base with two sets of cutting teeth extending from it that are oriented in a manner functionally equivalent to that in the preferred embodiment, i.e. with a first set of cutting teeth being oriented at an angle relative to a line through the midpoint of the teeth and being generally parallel to each other, a second set of such teeth, the two sets being generally parallel to each other and spaced apart and with the angle of the teeth of the second set being oriented in an opposite direction to the angle of the teeth of the first set, and in an offset position relative to the teeth of the first set.

As will be apparent to those skilled in the art in the light of the foregoing disclosure, many alterations and modifications are possible in the practice of this invention without departing from the spirit or scope thereof. For example, the apparatus of the invention may have ultrasonic cutting means instead of or in addition to the blades 12; and the method of cutting a line of perforation may include the step of providing a cutting apparatus which performs ultrasonic cutting. Accordingly, the scope of the invention is to be construed in accordance with the substance defined by the following claims.

What is claimed is:

1. An apparatus for cutting a line of perforation in a sheet of material, comprising:
(a) a first cutting blade having a base and a plurality of teeth, said teeth being oriented at an angle relative to said base and being generally parallel to each other;
(b) a second cutting blade having a base and a plurality of teeth, said teeth being oriented at an angle relative to said base and being generally parallel to each other; and
(c) holding means for holding said first and second cutting blades at a selected distance from each other and in a generally parallel orientation and with said angle of said teeth of said second cutting blade being oriented in an opposite direction to said angle of said teeth of said first cutting blade, and with said teeth of said second cutting blade in an offset position relative to said teeth of said first cutting blade.

2. An apparatus according to claim 1 wherein said angle of said teeth of said first and second cutting blades is in the range of 5 to 70 degrees.

3. An apparatus according to claim 1 wherein said angle of said teeth of said first and second cutting blades is in the range of 20 to 45 degrees.

4. An apparatus according to claim 1 wherein said distance between said between said first and second cutting blades is in the range of 1/32 to ¼ inches.

5. An apparatus according to claim 1 wherein said distance between said between said first and second cutting blades is approximately 1/16 inches.

6. An apparatus according to claim 1 wherein said teeth of said second blade are offset relative to said teeth of said first blade by a distance of approximately one half the width of said tooth.

7. An apparatus for cutting a line of perforation in a sheet of material, comprising:
(a) a base;
(b) a first set of cutting teeth extending from said base, said teeth being oriented at an angle relative to a line through a mid-point of said teeth, said teeth being generally parallel to each other;
(c) a second set of cutting teeth extending from said base, said teeth being oriented at an angle relative to a line through a mid-point of said teeth, said teeth being generally parallel to each other;
(d) said first set of teeth being generally parallel to said second set of teeth and spaced therefrom by a selected distance and with said angle of said teeth of said second set being oriented in an opposite direction to said angle of said teeth of said first set, and with said teeth of said second set in an offset position relative to said teeth of said first set.

8. An elongated sheet of flexible material having generally parallel longitudinal edges and a line of perforation extending between said longitudinal edges, said line of perforation comprising:
(a) a first set of cuts which are spaced apart and are generally parallel to each other and at a selected angle relative to a line perpendicular to said longitudinal edges;
(b) a second set of cuts which are spaced apart and are generally parallel to each other and at a selected angle relative to a line perpendicular to said longitudinal edges;
(c) said second set of cuts being spaced at a selected distance from and being generally parallel to said first set of cuts; and
(d) said cuts of said second set being offset relative to said cuts of said first set in a direction perpendicular to said longitudinal edges.

9. A sheet according to claim 8 wherein said angle of said cuts of said first and second sets is in the range of 5 to 70 degrees.

10. A sheet according to claim 8 wherein said angle of said cuts of said first and second sets is in the range of 20 to 45 degrees.

11. A sheet according to claim 8 wherein said distance between said between said first and second sets of cuts is in the range of 1/32 to ¼ inches.

12. A sheet according to claim 8 wherein said distance between said between said first and second sets of cuts is approximately 1/16 inches.

13. A sheet according to claim 8 wherein said cuts of said second set are offset relative to said cuts of said first set by a distance of approximately one half a length of said cut.

14. A sheet according to claim 8 comprising a plurality of said lines of perforation spaced apart from each other, said sheet having a plurality of sections, adjacent sections being separated by one of said lines of perforation.

15. A method for cutting a line of perforation in a sheet of material, comprising the steps of:
(a) providing an apparatus comprising:
(i) a first cutting blade having a base and a plurality of teeth, said teeth being oriented at an angle relative to said base and being generally parallel to each other;
(ii) a second cutting blade having a base and a plurality of teeth, said teeth being oriented at an angle relative to said base and being generally parallel to each other; and
(iii) holding means for holding said first and second cutting blades at a selected distance from each other and in a generally parallel orientation and with said angle of said teeth of said second cutting blade being oriented in an opposite direction to said angle of said teeth of said first cutting blade, and with said teeth of said second cutting blade in an offset position relative to said teeth of said first cutting blade; and
(b) bringing said apparatus into contact with said sheet in a manner such that said teeth of said apparatus perforate said sheet.
